(19) United States
(12) Patent Application Publication
(10) Pub. No.: US 2026/0268224 A1
(43) Pub. Date: Sep. 10, 2026

(54) INFORMATION PROCESSING APPARATUS, METHOD, AND NON-TRANSITORY COMPUTER-READABLE STORAGE MEDIUM

(71) Applicant: ADANSONS CORP., Palo Alto, CA (US)

(72) Inventors: Kenichi HIGUCHI, Sendai-shi (JP); Yushi NAKAYA, Sendai-shi (JP); Haruki ISHII, Sendai-shi (JP); Yoshitaka KIMURA, Sendai-shi (JP)

(73) Assignee: ADANSONS CORP., Palo Alto, CA (US)

(21) Appl. No.: 19/653,503

(22) Filed: Apr. 21, 2026

Related U.S. Application Data
(63) Continuation of application No. PCT/JP2024/034613, filed on Sep. 27, 2024.

(30) Foreign Application Priority Data
Nov. 20, 2023 (JP) 2023-196973

(51) Int. Cl. G06N 20/00

(52) U.S. Cl. CPC G06N 20/00

(57) ABSTRACT

An information processing apparatus with processing circuitry to store a learning model; obtain a data set of items each associated with an item of metadata; and evaluate, on the data set, for each of a plurality of groups each including one or more items of data, an inference quality of the learning model for the one or more items of data included in the group. A program including a processor and a storage, the processor executes: a step of storing a learning model; a step of obtaining a data set including a plurality of items of data each associated with an item of metadata; and, on the data set obtained in the data obtaining step, a step of evaluating inference qualities of learning model for one or more items of data included in the group for each of a plurality of groups each including one or more items of data.

### CROSS-REFERENCE TO RELATED APPLICATIONS

This application is a continuation of International Application No. PCT/JP2024/34613, filed Sep. 27, 2024, which claims priority to Japanese Patent Application No. 2023-196973, filed Nov. 20, 2023, the entire contents of each are incorporated herein by reference.

### FIELD

The present disclosure relates to an information processing apparatus, method, non-transitory computer-readable storage medium.

### BACKGROUND

Techniques of checking the reliability of an artificial intelligence model or the like are known.

Conventional system discloses a technique of mitigating degradation in recognition accuracy even for a large number of target objects.

Conventional system discloses a technique of providing an image analyzing apparatus and the like that recognizes a physical object based on a reference image from an analysis target image even in the presence of a plurality of feature points having identical or similar local features in the reference image.

### BRIEF DESCRIPTION OF DRAWINGS

FIG. 1 is a block diagram illustrating a functional configuration of a system 1.

FIG. 2 is a block diagram illustrating a functional configuration of a server 10.

FIG. 3 is a block diagram illustrating a functional configuration of a user terminal 20.

FIG. 4 is a diagram illustrating the data structure of a user table 1012.

FIG. 5 is a diagram illustrating the data structure of a data table 1013.

FIG. 6 is a diagram illustrating the data structure of an evaluation table 1014.

FIG. 7 is a diagram illustrating the data structure of a model table 1021.

FIG. 8 is a diagram illustrating the data structure of a group table 1022.

FIG. 9 is a diagram illustrating the data structure of a submodel table 1023.

FIG. 10 is a flowchart illustrating the operation of a quality evaluation process.

FIG. 11 is a flowchart illustrating the operation of a combined model inference process.

FIG. 12 is a block diagram illustrating a functional configuration of a combined model.

FIG. 13 is a first screen example illustrating the operation of the quality evaluation process.

FIG. 14 is a second screen example illustrating the operation of the quality evaluation process.

FIG. 15 is a block diagram illustrating a basic hardware configuration of a computer 90.

### DETAILED DESCRIPTION

In general, according to one embodiment, a program to be executed by a computer including a processor and a storage, wherein the processor executes: a model storing step of storing a learning model; a data obtaining step of obtaining a data set including a plurality of items of data each of which is associated with an item of metadata; and, on the data set obtained in the data obtaining step, a model evaluating step of evaluating inference qualities of learning model for one or more items of data included in the group for each of a plurality of groups each including one or more items of data.

An embodiment of the present disclosure will be described below with reference to the drawings. In all of the drawings used for illustrating the embodiment, the same constituent components are denoted by the same reference characters, and repetitive descriptions thereof will be omitted. Note that the embodiment described below is not to be construed as unreasonably limiting the content of the present disclosure described in the claims. In addition, all of the constituent components described in the embodiment are not necessarily essential for the present disclosure. Each of the drawings is schematic and is not necessarily an exact illustration.

### Configuration of System 1

A system 1 in the present disclosure is an information processing system that evaluates the quality of a learning model.

The learning model includes any artificial intelligence model such as a machine learning, artificial intelligence, or deep learning model.

The quality of the learning model includes an index indicating any type of quality pertaining to an artificial intelligence model, such as versatility, accuracy, robustness, speed and efficiency, or reliability.

The system 1 includes information processing apparatuses: a server 10 and user terminals 20, which are connected via a network N.

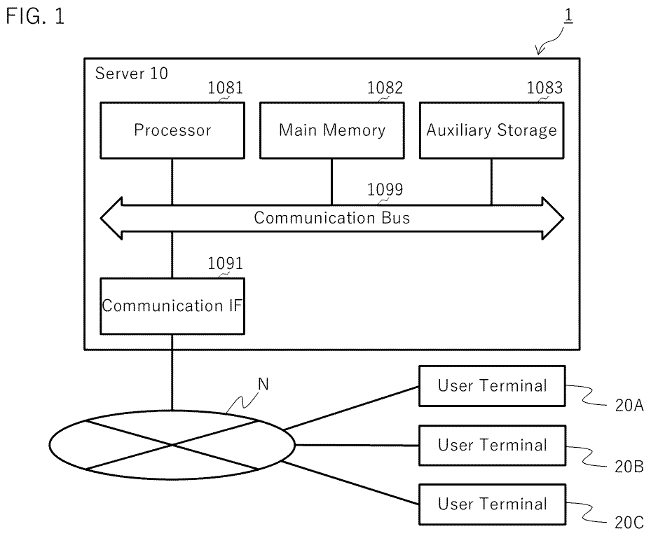

FIG. 1 is a block diagram illustrating a functional configuration of the system 1.

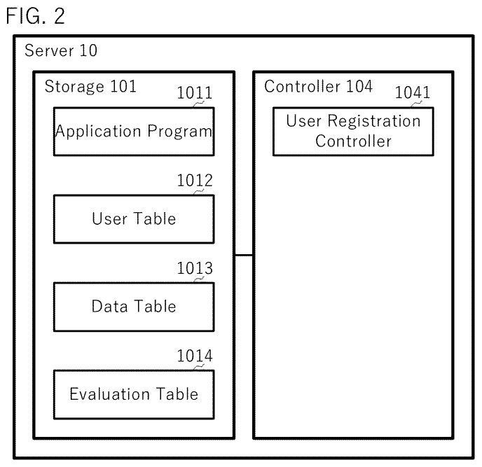

FIG. 2 is a block diagram illustrating a functional configuration of the server 10.

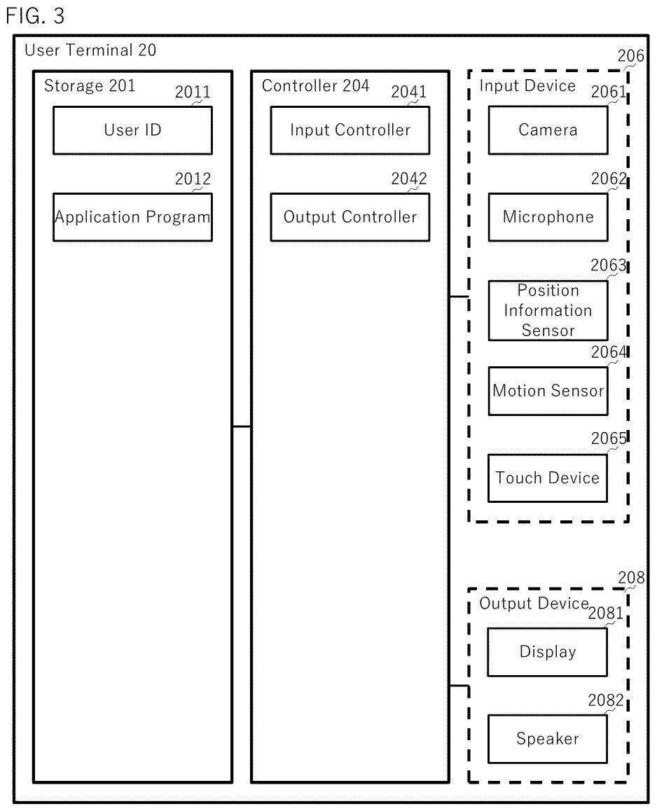

FIG. 3 is a block diagram illustrating a functional configuration of a user terminal 20.

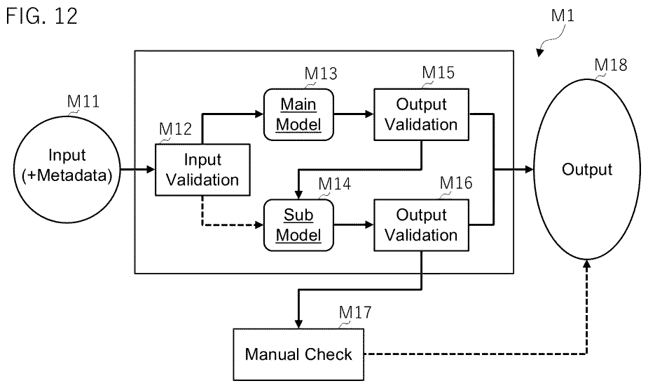

FIG. 12 is a block diagram illustrating a functional configuration of a combined model.

Each of the information processing apparatuses is configured with a computer including a computing device and a storage device. The basic hardware configuration of the computer and the basic functional configuration of the computer, which is implemented with the hardware configuration, will be described later. For the server 10 and the user terminal 20, the descriptions thereof that overlap with the description of the basic hardware configuration of the computer and the basic functional configuration of the computer to be described later will be omitted.

In the present disclosure, the user terminal 20 and the server 10 are made to have different device configurations as an example. However, the device configurations are not limited to this. Specifically, the configuration of the user terminal 20 may be made to include the entire configuration of the server 10. In this case, the user terminal 20 can execute information processing according to the present disclosure with a single stand-alone configuration. In addition, the hardware configuration for implementing the information processing system may be provided in any system configuration within the scope in which the information processing according to the present disclosure can be executed.

### Configuration of Server 10

The server 10 is an information processing apparatus that provides an information processing service of evaluating the quality of a learning model.

The server 10 includes a storage 101 and a controller 104.

### Configuration of Storage 101 of Server 10

The storage 101 of the server 10 includes an application program 1011, a user table 1012, a data table 1013, an evaluation table 1014, a model table 1021, a group table 1022, and a submodel table 1023.

The application program 1011 is a program that causes the controller 104 of the server 10 to function as functional units.

The application program 1011 includes an application such as a web browser application.

The user table 1012 is a table that stores and maintains information on member users who use the service (hereinafter, users). When a user performs usage registration for the service, information on the user is stored in a new record of the user table 1012. The user is thus enabled to use the service according to the present disclosure.

The user table 1012 is a table including columns of user ID and user name, where the user ID is its primary key.

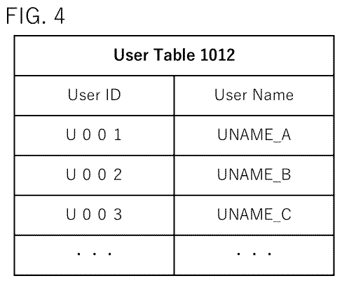

FIG. 4 is a diagram illustrating the data structure of the user table 1012.

The user ID is an entry that stores user identification information for identifying a user. The user identification information is an entry to which a value unique to each user is set.

The user name is an entry in which the name of a user is stored. To the user name, any character string such as a nickname may be set, rather than the name.

The data table 1013 is a table that stores and maintains a data set (test data) to be used to evaluate the quality (versatility) of a learning model (main model). Note that the data table 1013 may be configured to store any data set to be used to input training data, verification data, and the like into the learning model.

The data table 1013 is a table including columns of data ID, user ID, data, and metadata, where the data ID is its primary key.

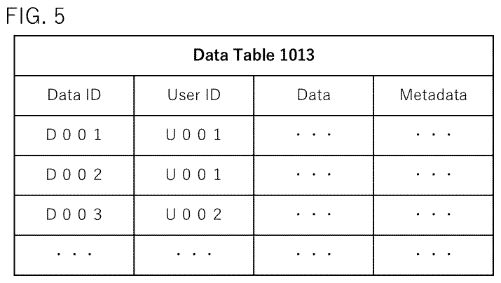

FIG. 5 is a diagram illustrating the data structure of the data table 1013.

The data ID is an entry that stores data identification information for identifying an item of data. The data identification information is an entry to which a value unique to each piece of data information is set.

The user ID is an entry that stores user identification information for identifying a user.

The data includes any structured data and unstructured data such as image data, video data, text data, audio data, and the like.

In the evaluation of the quality of an artificial intelligence model, such as a physical object detection model to be used in automated driving, the data includes the following types of information.
Image data

The image data includes still image data from an on-board camera. The still image data contains a road marking, another vehicle, a pedestrian, an obstacle, and the like. In the present disclosure, the image data may include video data.
Video data

The video data includes time-series movie data that is output from the on-board camera or another sensor.

The video data includes a movie of movements of another vehicle, a pedestrian, a bicycle, and the like pertaining to a traffic situation, an intersection, a crosswalk, a change in a traffic light, the conditions of a road ahead or less-frequently traveling road.

The video data includes a movie pertaining to various types of weather such as sunny, rainy, snowy, and foggy weather pertaining to weather conditions and includes a movie of daytime, nighttime, or crepuscule.

The video data includes a movie pertaining to a roadway such as an expressway, urban area, country road, mountain road pertaining to types of road.

The video data includes a movie of a traffic sign, a signal, a road marking, and the like pertaining to traffic rules.
Text data

The text data includes log data from a vehicle sensor or data that is obtained from an external information source (e.g., traffic information or weather forecast).
Audio data

The audio data includes an audio input from an on-board microphone or information on ambient sound input from an off-board microphone.

The metadata includes annotation information, ground truth labels in the physical object detection model, a classification model, or the like, and the like that are stored in association with the data.

The image data in the data to be used in the artificial intelligence model used for automated driving or the like, such as the physical object detection model, includes any supplementary information that is obtained from log data from a vehicle sensor or an external information source when the data is created.

The supplementary information includes the following information.
Data from measurements by various sensors such as a camera, a sunlight sensor, and accelerometer, other than the data to be input into the learning model such as the main model
Log data on event occurrence records, nearby traffic situations that are collected separately from the data to be input into the learning model such as the main model.
Information that supplements the data to be input into the learning model such as the main model or an environment in which the learning model of a vehicle or the like is operated, such as information about a date and time, place, situation of a measurement, and an event that occurs before or after the measurement.
Information representing an electronic attribute of data, such as a file size.
Data obtained by performing a given process on one or more items of the data described above.
Any other information that relates to or is presumed to relate to the one or more items of the data described above.

The metadata in the present disclosure may include internal features output from an internal layer of the learning model such as the main model, output data output from the learning model such as the main model, input data input into the learning model such as the main model, data obtained by subjecting the input data to a given process, or the combination of a plurality of items of metadata. The metadata in the present disclosure includes first metadata including the internal features output from the internal layer of the learning model such as the main model, second metadata not including the internal features output from the internal layer of the learning model such as the main model, third metadata being the output data output from the learning model such as the main model, fourth metadata being the input data input into the learning model such as the main model, fifth metadata being the data obtained by subjecting the input data to the given process, and any one, or two or more combinations of the first metadata to the fifth metadata.

The metadata in the present disclosure may include data on a quantitative measurement of the difference between a prediction calculated by the model in learning evaluation and ground truth data, the value of an evaluation function/loss function, a value that means an error pattern (Example 1: mistakenly predicting a dog as a cat, Example 2: mistakenly predicting a cat as a dog), and a value of a quantified reliability of the prediction.

The internal features include, for example, the following types of information.

In the case of a convolutional neural network (CNN) used to classify input images, the internal features include output data from layers from an input layer receiving an image to a fully connected layer, which receives convoluted data as input data and outputs input data to be input into an activation function, such as the Softmax function, used in an output layer (classification layer) outputting a classification. A CNN executes a final classification on the basis of the internal features output from the completely connect layer.

The internal features include, in addition to the output data output from the layers in the network described above, weight parameters used in the calculation in each of the layer and information used or generated in a calculation process, such as gradient.

In tasks other than classifying, the internal features include output data that generates a final prediction in each task and information used or generated in the calculation process of the prediction. For example, in physical object detection, the internal features include the coordinate position of a physical object (bounding box) and the classification of the physical object.

In the present disclosure, in the case of performing the performance evaluation and the quality evaluation (including a quality evaluation process) of the main model, one or more appropriate internal features may be selected from among the internal features described above for each task. Specifically, the quality evaluation process may include a step of selecting one or more internal features effective for the quality evaluation from among a plurality of candidates for internal features (feature candidates) on the basis of the result of evaluating the main model.

For example, a first quality evaluation process is executed on the basis of the combinations of a plurality of internal features (taken as a first internal feature set and a second internal feature set), and the result of evaluating the first internal feature set and the result of evaluating the second internal feature set are compared. The quality evaluation process may include the process of selecting, in the case where the result of the evaluation based on the first internal feature set is superior to the result of the evaluation based on the second internal feature set, the first internal feature set as internal features to be used in a second quality evaluation process.

The evaluation table 1014 is a table that stores and maintains the result of evaluating (evaluation information on) the main model for each item of data.

The evaluation table 1014 is a table including columns of main model ID, data ID, inference data, and error data.

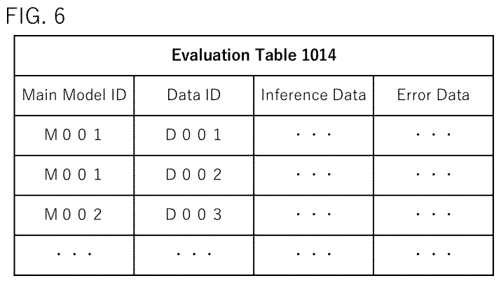

FIG. 6 is a diagram illustrating the data structure of the evaluation table 1014.

The main model ID is an entry that stores main model identification information for identifying a main model.

The data ID is an entry that stores data identification information for identifying an item of data.

The inference data stores output data that is output (inferred) from a main model (learning model) specified with a main model ID in the case where data specified with a data ID (test data) is applied as input data for the main model.

The error data is an entry that stores information indicating the detail, type, and the like of an error determined as a result of the comparison between inference data and metadata on data specified with a data ID.

Specifically, an item of the error data includes the type (error code) of an error and information indicating the detail of the error (character string information indicating the detail of the error) as shown below.
Label Error: indicating a fault in labeling in a data set. A label error indicates an inaccurate item of learning data and can thus have an adverse effect on training a model. For example, if an image of a cat is labeled as a “dog,” the model learns this false information. A label error often occurs due to a human error in the process of data collecting or annotation, or a fault in an automated labeling process.
EdgeCase: indicating a case where, in a classification task or the like, a model makes a mistake between similar categories or between categories that differ only slightly, such as between “car” and “pickup truck.”
False Positive (FP): indicating a case where data is falsely predicted to be a class that is not actually true.
False Negative (FN): indicating a case where data that should be predicted to be a class is not predicted to be the class.
Overfitting: indicating a state where the model overfits training data but cannot be generalized well for new, unknown data.
Bias: indicating a case where the prediction is biased for a specific class or property.
Variance: indicating a case where the prediction varies significantly for a different data set or in a different environment.

The model table 1021 is a table that stores and maintains main models to be evaluated for qualities. In the present disclosure, an example in which the learning model is permanently stored in the model table 1021, as an example, but storing the learning model is not limited to this. The configuration can be such that, for example, a learning model is stored in a volatile storage medium capable of high-speed reading and writing, such as a memory (RAM or the like) included in the server 10. Specifically, in the execution of the quality evaluation process or a combined model inference process according to the present disclosure, the process of temporarily loading a learning model received from the outside of the server 10 on the volatile storage medium may be executed. In this case, information processing can be executed at high speed even on a large-scale learning model.

The model table 1021 is a table including columns of main model ID, user ID, main model, and model quality, where the main model ID is its primary key.

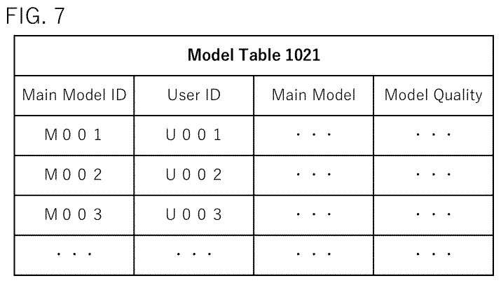

FIG. 7 is a diagram illustrating the data structure of the model table 1021.

The main model ID is an entry that stores main model identification information for identifying a main model. The main model identification information is an entry to which a value unique to each main model is set.

The user ID is an entry that stores user identification information for identifying a user.

The main model is an entry that stores data on a learning model relating to a main model to be evaluated for quality.

A learning model is an inference model that outputs (infers) output data in response to the input of input data.

The input data may include information about image data, video data, text data, and audio data. The output data may include information about metadata.

The process of training the learning model will be described later.

The learning model is a type of, for example, machine learning, artificial intelligence, deep learning model, and the like.

The learning model need not be a single learning model. The learning model may be implemented with a plurality of independent learning models that are switched to one another.

As an example of the learning model, a deep learning model constituted by a deep neural network in deep learning will be described. The learning model need not necessarily be a deep learning model. The learning model may be any machine learning model or artificial intelligence model.

The model quality is an entry that stores information indicating the result of evaluating the quality of the main model.

Specifically, the model quality is an entry that stores an index indicating to what extent a learning model relating to a main model can appropriately infer a data set relating to data.

In the present disclosure, the model quality includes a coverage of the number of data sets that can be appropriately inferred (without errors) with respect to the number of data sets in data.

The model quality includes evaluation indices of inference quality such as accuracy, precision, recall, F1 score, mean absolute error, and mean squared error.

The group table 1022 is a table that stores and maintains information about groups (group information).

The group table 1022 is a table including columns of group ID, main model ID, data IDs, data count, metadata, error data, and group quality, where the group ID is its primary key.

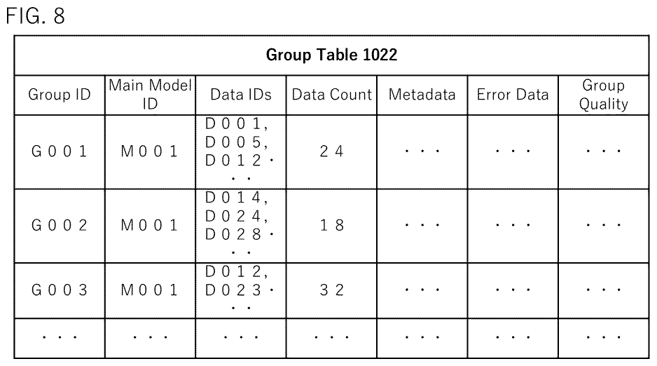

FIG. 8 is a diagram illustrating the data structure of the group table 1022.

The group ID is an entry that stores group identification information for identifying a group. The group identification information is an entry to which a value unique to each piece of group information is set.

The main model ID is an entry that stores main model identification information for identifying a main model.

The data IDs is an entry that stores data identification information on data belonging to a group. The data IDs stores one or more pieces of data identification information.

The data count is an entry that stores the number of items of data belonging to a group.

The metadata is an entry that stores metadata that represents (characterizes) a group.

The metadata need not necessarily be stored in association with a group. In the present disclosure, it is only required that at least any one of metadata and error data be stored in association with each group.

The error data is an entry that stores information indicating the detail and type of an error representing (characterizing) a group.

The group quality is an entry that stores information indicating the result of evaluating the inference quality of the main model for data belonging to a group. The group quality includes information for comprehensively understanding the execution result, importance, and effect of a model.

Specifically, the group quality includes the following information.

Evaluation indices of inference quality such as accuracy, precision, recall, F1 score, mean absolute error, and mean squared error.
counts_total: indicating the total data count of items of data belonging to a group. This enables grasping the scale of data to be evaluated.
model_effect_score: indicating the influence of specific data on an output result from a model. Specifically, the group quality is represented as the total sum of values of a loss function for items of data belonging to the group and serves as an index indicating how much the data adversely affects the main model. Instead of the loss function, any index that quantifies the quality of the prediction of the data or the degree of the adverse effect on the operation may be used.
priority_score: indicating an index that is weighted for model_effect_score on the basis of another metric, such as the easiness, necessity, or urgency of improvement. For example, in the case where the improvement is highly easy for specific data, a score weighted for model_effect_score on the basis of a predetermined priority serves as priority_score.

The submodel table 1023 is a table that stores and maintains submodels.

The submodel table 1023 is a table including columns of submodel ID, main model ID, submodel, and application condition, where the submodel ID is its primary key.

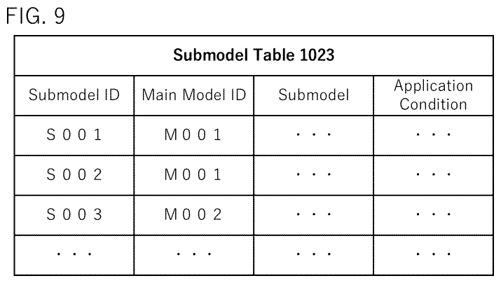

FIG. 9 is a diagram illustrating the data structure of the submodel table 1023.

The submodel ID is an entry that stores submodel identification information for identifying a submodel. The submodel identification information is an entry to which a value unique to each piece of submodel information is set.

The main model ID is an entry that stores main model identification information for identifying a main model.

The submodel is an entry that stores data on a learning model relating to a submodel.

The application condition is an entry that defines the range of an application condition for input data under which a submodel is applied instead of a main model. Specifically, the application condition stores information indicating the range of metadata on the input data.

The application condition may include one or more group IDs (group IDs) that specify one or more groups to which a submodel is applied. For example, on the basis of the group IDs, the entry of the group ID of the group table 1022 is looked up to specify data IDs. On the basis of the specified data IDs, the entry of the data ID of the data table 1013 is looked up to specify metadata. The configuration can be such that, on the basis of the metadata, the range of an application condition for input data to which a submodel is applied instead of a main model is defined.

### Configuration of Controller 104 of Server 10

The controller 104 of the server 10 includes a user registration controller 1041. The controller 104 executing the application program 1011 stored in the storage 101 implements the functional units.

The user registration controller 1041 performs the process of storing, in the user table 1012, information on a user who desires the use of the service according to the present disclosure.

The information to be stored in the user table 1012 is input by the user, who opens a web page or the like operated by a service provider with a given information processing terminal, inputting the information on a predetermined entry form, and transmitted to the server 10. The user registration controller 1041 stores the received information in a new record of the user table 1012, and thus user registration is completed. This allows the user stored in the user table 1012 to use the service.

Before the registration of the information on the user in the user table 1012 by the user registration controller 1041, the service provider may perform a predetermined judgment to control whether to allow the user to use the service.

A user ID may be any character string or numeral with which a user can be identified. Any character string or numeral desired by the user may be set, or any character string or numeral may be automatically set by the user registration controller 1041.

### Configuration of User Terminal 20

The user terminal 20 is an information processing apparatus operated by a user who uses the service. The user terminal 20 may be, for example, a mobile terminal such as a smartphone, a tablet or may be a desktop personal computer (PC) or a laptop PC. Alternatively, the user terminal 20 may be a wearable terminal such as a head mount display (HMD) or a smartwatch.

The user terminal 20 includes a storage 201, a controller 204, an input device 206, and an output device 208.

### Configuration of Storage 201 of User Terminal 20

The storage 201 of the user terminal 20 includes a user ID 2011 and an application program 2012.

The user ID 2011 is the account ID of a user. The user transmits the user ID 2011 from the user terminal 20 to the server 10. On the basis of the user ID 2011, the server 10 identifies the user and provides the user with the service according to the present disclosure. Note that the user ID 2011 includes information on a session ID and the like that are temporarily given by the server 10 to identify the user using the user terminal 20.

The application program 2012 may be stored in the storage 201 in advance or may be downloaded via a communication IF from a web server or the like that is operated by the service provider.

The application program 2012 includes an application such as a web browser application.

The application program 2012 includes an interpreted programming language to be executed on the web browser application stored in the user terminal 20, such as JavaScript (R).

### Configuration of Controller 204 of User Terminal 20

The controller 204 of the user terminal 20 includes an input controller 2041 and an output controller 2042. The controller 204 executing the application program 2012 stored in the storage 201 implements functional units.

### Configuration of Input Device 206 of User Terminal 20

The input device 206 of the user terminal 20 includes a camera 2061, a microphone 2062, a positional information sensor 2063, a motion sensor 2064, and a touch device 2065.

### Configuration of Output Device 208 of User Terminal 20

The output device 208 of the user terminal 20 includes a display device 2081, and a loud speaker 2082.

### Operation by System 1

Processes by the system 1 will be described below.

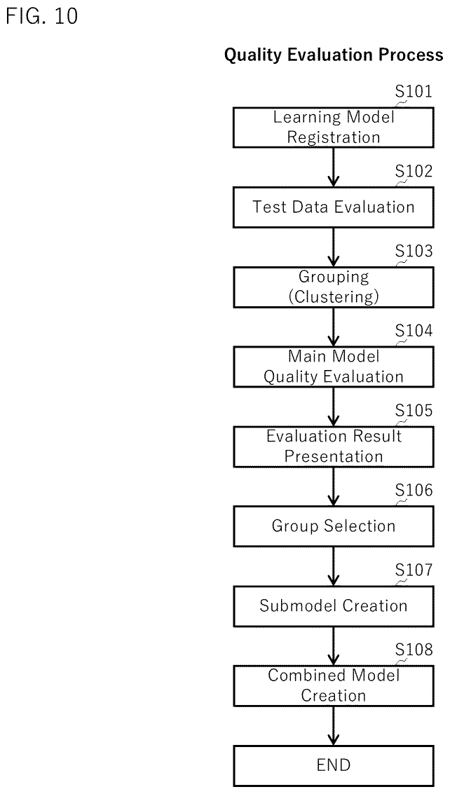

FIG. 10 is a flowchart illustrating the operation of the quality evaluation process.

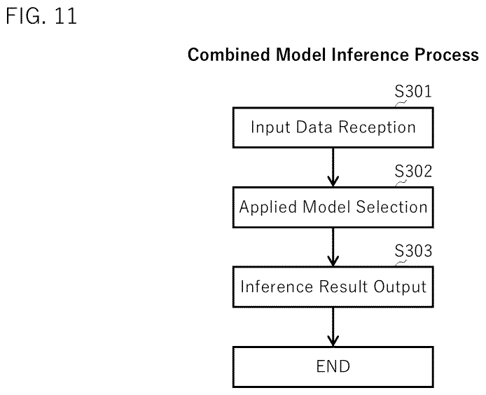

FIG. 11 is a flowchart illustrating the operation of the combined model inference process.

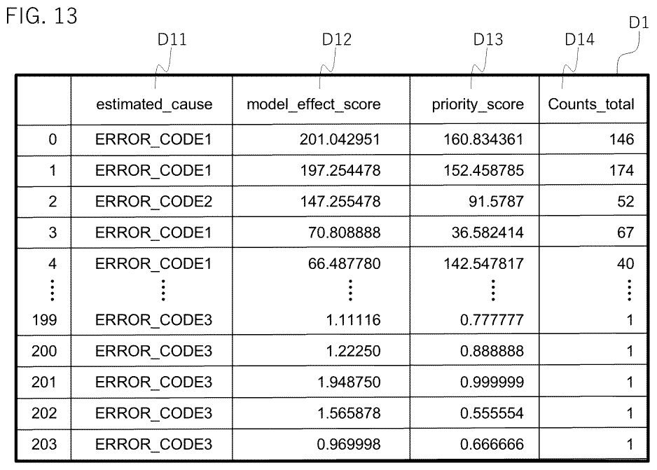

FIG. 13 is a first screen example illustrating the operation of the quality evaluation process.

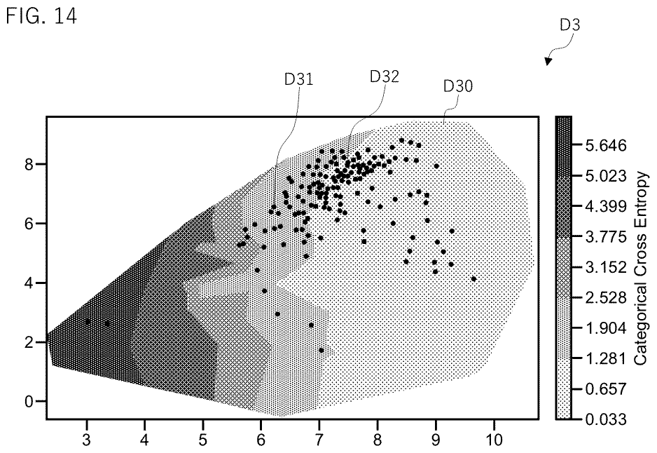

FIG. 14 is a second screen example illustrating the operation of the quality evaluation process.

### Quality Evaluation Process

The quality evaluation process is the process of evaluating the quality of a learning model (main model) and presenting the result of the evaluation. The quality evaluation process may include the process of creating a submodel that is superior in quality to a part of the main model on the basis of the result of the evaluation.

### Outline of Quality Evaluation Process

The quality evaluation process is a series of processes of evaluating a data set constituted by a plurality of items of test data by applying the data set to the main model, grouping (clustering) the data set on the basis of the result of the evaluation or metadata, evaluating the quality of the main model, visualizing the result of the evaluation, accepting the selection of a predetermined group, and creating a submodel that is the main model improved within an application range defined on the basis of the predetermined group that has been selected.

### Details of Quality Evaluation Process

The quality evaluation process will be described in detail.

In step S101, the controller 104 of the server 10 executes a model storing step of storing a learning model.

A user operates the input device 206 of the user terminal 20 to input a URL of a page for executing the quality evaluation process (a quality evaluation process page) into a web browser or the like, to open the quality evaluation process page. The controller 204 of the user terminal 20 transmits a request to open the quality evaluation process page to the server 10. On the basis of the received request, the controller 104 of the server 10 generates the quality evaluation process page and transmits the quality evaluation process page to the user terminal 20. The controller 204 of the user terminal 20 displays the received quality evaluation process page on the display device 2081 of the user terminal 20.

The user operates the input device 206 of the user terminal 20 and selects a file upload button or the like provided on the quality evaluation process page to select a learning model to be subjected to the quality evaluation in the quality evaluation process that is stored in a given place such as the storage 201 of the user terminal 20 or a predetermined cloud computing service. The controller 204 of the user terminal 20 transmits the user ID 2011 and the selected learning model to the server 10. The controller 104 of the server 10 stores the received user ID and learning model, in the entries of the user ID and the main model of a new record of the model table 1021, respectively. As a main model ID, main model identification information is newly numbered. In the present disclosure, the learning model stored in this step will be called a main model.

Note that the user may operate the input device 206 of the user terminal 20 to execute a command line or a given program, so as to store the learning model to be subjected to the quality evaluation in the quality evaluation process, in the model table 1021.

In step S102, the controller 104 of the server 10 executes a data obtaining step of obtaining a data set constituted by a plurality of items of data each of which is associated with an item of metadata.

The user selects a file upload button or the like provided on the quality evaluation process page by operating the input device 206 of the user terminal 20, thus selecting a data set that is constituted by a plurality of items of test data to be used to evaluate the quality of the learning model in the quality evaluation process and is stored in a given place such as the storage 201 of the user terminal 20 or a predetermined cloud computing service. Note that each of the plurality of items of test data is stored in association with an item of metadata. The controller 204 of the user terminal 20 transmits the user ID 2011 and the selected data set to the server 10. The controller 104 of the server 10 stores the received user ID, and the plurality of items of test data included in the data set, and the items of metadata, in the entries of the user ID, the data, and the metadata of new records of the data table 1013, respectively. In the entries of the data and the metadata of the data table 1013, the plurality of items of test data included in the data set are stored in association with the items of metadata. As a data ID, data identification information is newly numbered.

Note that the user may operate the input device 206 of the user terminal 20 to execute a command line or a given program, so as to store the plurality of items of test data and the items of metadata to be used to evaluate the quality of the learning model in the quality evaluation process, in the data table 1013.

The controller 104 of the server 10 applies the plurality of items of data (test data) stored in the data table 1013 to the main model as items of input data, and obtains internal features and a plurality of items of output data as an inference result. The controller 104 of the server 10 compares each of the plurality of items of output data with an item of metadata (ground truth data) that is stored in association with the internal features and each of the items of input data (test data) to evaluate the inference quality of the main model pertaining to whether the item of output data is correct or incorrect. Specifically, the controller 104 of the server 10 determines that an item of the output data is correct in the case where the item of output data matches a corresponding item of the ground truth data, and determines that the item of output data is incorrect in the case where the item of output data does not match the corresponding item of the ground truth data.

For example, in the case where the main model is a classification model, the main model outputs an output label (classification label) in response to the input of an item of input data. The controller 104 of the server 10 compares the output label that has been output with a ground truth label included in an item of metadata stored in association with each of the items of input data. For each of the plurality of items of input data, the controller 104 of the server 10 determines that the corresponding item of the output data is correct in the case where the output label matches the ground truth label, and determines that the corresponding item of the output data is incorrect in the case where the output label does not match the ground truth label.

Note that in the case of the combination of an item of output data and an item of ground truth data for which correctness/incorrectness of the item of output data cannot be determined or in the case of no item of ground truth data, the inference quality of the main model may be evaluated using any index.

In the case where an item of output data is incorrect (in the case where the inference result is false), the controller 104 of the server 10 specifies information indicating the detail of the fault relating to the reason for the incorrectness (fault information). The information indicating the detail of the fault includes, for example, an error code (fault type information pertaining to the type of the fault in the inference result) such as Label Error or EdgeCase. For example, in the case where the error code is Label Error, the information indicating the detail of the fault includes information (character string information or the like) about the detail of the fault, such as “The dog image labeled as a cat” or “The position or size of the boundary box is inaccurate.” For example, in the case where the error code is Edge Case, the information includes information indicating the detail of the error, such as “Detection failure under specific light condition” or “false detection of physical object in unusual attitude or from unusual viewpoint.”

Note that the information indicating the detail of the fault may be specified by the controller 104 of the server 10 by using a given machine learning model, deep learning model, artificial intelligence model, or the like or may be specified through human work by a user, on the basis of an item of output data and the corresponding item of metadata. This can obtain the result of evaluating the inference quality including an index for measuring accuracy and error in the prediction performed on the data set by the main model.

The controller 104 of the server 10 stores the main model ID, the data IDs of items of input data, items of output data, and pieces of information indicating the detail of a fault, in the entries of the main model ID, the data ID, the inference data, and the error data of new records of the evaluation table 1014, respectively. Note that, in the case where the inference result is “correct,” or the inference result can be regarded as having no error defined by any index, null or a blank may be stored (nothing may be stored) in the error data.

Thus, the result of evaluating the inference quality for the test data is stored in the evaluation table 1014 as the evaluation information.

Note that although the present disclosure discloses, as an example, the example of executing the quality evaluation process on the basis of the fault information, the configuration may be such that, in the case where the output data is correct (the inference result is true), information indicating the detail of the correctness relating to the reason for the correctness (correctness information) is specified.

Specifically, the configuration may be such that a clustering process (a first embodiment) and a clustering process (a second embodiment), which will be described later, are executed using the correctness information instead of the fault information. Furthermore, the configuration may be such that the quality evaluation process and the combined model inference process are executed using the correctness information instead of the fault information.

Alternatively, the configuration may be such that the clustering process (the first embodiment) and the clustering process (the second embodiment), which will be described later, are executed using both the fault information and the correctness information (correctness-fault information). Furthermore, the configuration may be such that the quality evaluation process and the combined model inference process are executed using the correctness-fault information.

### Clustering Process (First Embodiment)

In step S103, the controller 104 of the server 10 executes a clustering step of executing clustering based on the similarities among items of metadata to a data set obtained in the data obtaining step and specifying a cluster formed by the clustering as a group.

Specifically, the controller 104 of the server 10 searches the entry of the user ID of the data table 1013 on the basis of the user ID 2011 and obtains a data set constituted by a plurality of data IDs, items of data, and items of metadata. The controller 104 of the server 10 executes, on the plurality of items of data (test data) included in the data set, the clustering process for classifying the plurality of items of data into a plurality of different groups, on the basis of the similarities among the items of metadata.

Specifically, the similarities among the items of metadata are calculated in the form of the distances between the plurality of items of data in vector spaces of internal feature, capture data and time, time slot (morning, afternoon, night, and the like), traveling speed of a vehicle, positional information on a vehicle, weather information, and the like. As the distances between the items of data, any metric such as cosine similarity, Manhattan distance, or Euclidean distance can be selected.

On the basis of the distances between the plurality of items of data, the controller 104 of the server 10 classifies the plurality of items of data included in the data set into the plurality of groups (clusters), by using any clustering method such as hierarchical clustering, K-means, or DBSCAN.

For each of the plurality of groups, the controller 104 of the server 10 stores the main model ID, the data IDs of the items of data classified into the group, and the number of items of data classified into the group, in the entries of the main model ID, the data IDs, and the data count of a new record of the group table 1022. As a group ID, group identification information is newly numbered.

Note that group metadata that characterizes each group (e.g., a representative vector, a centroid vector, or the like, of the cluster) may be stored in the entry of the metadata of the group table 1022. The group metadata may be specified by a method to be described in Clustering Process (Second Embodiment).

The controller 104 of the server 10 executes a group quality evaluating step of applying each of one or more items of data included in a group specified in the clustering step, as an item of input data of the learning model that is stored in the model storing step, so as to obtain the inference result for each of the one or more items of data. The group quality evaluating step obtains fault information about a fault in the inference result for each of the one or more items of data.

Specifically, for a predetermined group, the controller 104 of the server 10 looks up the evaluation table 1014 and obtains evaluation information that is calculated for data included in the group. For predetermined group information, the controller 104 of the server 10 searches the entry of the data ID of the evaluation table 1014 on the basis of the plurality of data IDs stored in the data IDs of the group information and obtains a plurality of items of inference data and a plurality of items of error data corresponding to the plurality of items of data. Note that the evaluation information may be calculated in this step.

On the basis of the inference results obtained in the group quality evaluating step, the controller 104 of the server 10 executes a group quality specifying step of specifying a group inference quality that characterizes at least some groups of the plurality of groups.

For a predetermined group, the controller 104 of the server 10 calculates the evaluation indices of the inference quality of the main model in the predetermined group (group inference quality), such as accuracy, precision, recall, F1 score, mean absolute error, and mean squared error, in accordance with the content of a plurality of items of error data (the numbers of correctnesses and incorrectnesses) included in the predetermined group.

The controller 104 of the server 10 may also calculate the evaluation indices such as counts_total, model_effect_score, priority_score, and the like, which are described together with the entry of the group quality of the group table 1022.

Alternatively, the controller 104 of the server 10 may output, for the predetermined group, the group inference quality by applying the plurality of obtained items of inference data and error data to a given machine learning model, deep learning model, artificial intelligence model, or the like, as items of input data.

The group quality specifying step specifies group fault information and group fault type information, which characterize at least some groups of the plurality of groups.

Specifically, the controller 104 of the server 10 specifies, for the predetermined group, error data having the highest number of items among the plurality of obtained items of error data, as error data that characterizes the predetermined group (group error data).

For example, in the case where an error code relating to Label Error is the most frequent error code in the predetermined group, Label Error is specified as the error code (the group fault information, the group fault type information) that characterizes the predetermined group.

Note that the configuration may be such that, in the case where the inference quality of the predetermined group is sufficiently satisfactory, such as the case where an evaluation index of the inference quality is greater than a predetermined value, no error data characterizing the predetermined group is specified. That is, error data characterizing a group is not necessarily specified for all the groups. The configuration may be such that error data characterizing a group is specified for some of the groups.

Alternatively, the controller 104 of the server 10 may output, for the predetermined group, the group error data, the group fault information, and the group fault type information by applying the plurality of obtained items of inference data and error data to a given machine learning model, deep learning model, artificial intelligence model, or the like, as items of input data.

The group quality evaluating step obtains the group fault type information about the type of a fault in the inference result for each of the one or more items of data.

The controller 104 of the server 10 executes a group quality storing step of storing the group inference quality specified in the group quality specifying step in association with at least some of the plurality of groups.

The group quality storing step stores the group fault information and the group fault type information specified in the group quality specifying step in association with at least some of the plurality of groups.

Specifically, the controller 104 of the server 10 stores the evaluation indices of the inference quality of the main model that are calculated for a group and the error code that characterizes the group, in the entries of the group quality and the error data of a record that is specified with the group ID of the group in the group table 1022.

Thus, in the group table 1022, error data and group quality are stored in association with each of the groups classified into by the clustering.

### Clustering Process (Second Embodiment)

In step S103, the controller 104 of the server 10 executes a data inferring step of obtaining the inference result for each of the plurality of items of data included in the data set obtained in the data obtaining step by applying each of the plurality of items of data as an item of input data of the learning model stored in the model storing step.

The data inferring step obtains items of fault information about faults in the inference results and items of fault type information about the types of the faults in the inference results for at least some of the plurality of items of data.

Specifically, on the basis of the main model ID, the controller 104 of the server 10 searches the entry of the main model ID of the evaluation table 1014 to obtain evaluation information including data IDs, items of inference data, and items of error data. Thus, the controller 104 of the server 10 can obtain an inference result of the data set stored in the data table 1013, based on the main model.

In step S103, the controller 104 of the server 10 executes a clustering step of executing clustering based on the inference result obtained in the data inferring step and specifying a cluster formed by the clustering as a group.

The clustering step executes clustering on the data set obtained in the data obtaining step on the basis of the similarities among the items of fault information and the items of fault type information obtained in the data inferring step, and specifies a cluster formed by the clustering as a group.

Specifically, the controller 104 of the server 10 executes, on the plurality of items of data (test data) included in the data set, the clustering process for classifying the plurality of items of data into a plurality of different groups, on the basis of the similarities among the items of fault information in the items of error data.

Specifically, the items of fault information each include information about the type of a fault, such as an error code. The similarities among the items of fault information are calculated in the form of the distances between a plurality of items of data in a vector space defined on the basis of the type of the fault. As the distances between the items of data, any metric such as cosine similarity, Manhattan distance, or Euclidean distance can be selected.

On the basis of the distances between the plurality of items of data, the controller 104 of the server 10 classifies the plurality of items of data included in the data set into the plurality of groups (clusters), by using any clustering method such as hierarchical clustering, K-means, or DBSCAN.

Note that the items of fault information or the items of fault type themselves may be used as classification labels and classified into groups. For example, the data set may be classified according to error code into a group in which error data is LabelError, a group in which error data is EdgeCase, or the like. Note that an item of data in which nothing is stored in the error data (an item of data with a “correct” inference result) may be classified into a group that indicates no error.

For each of the plurality of groups, the controller 104 of the server 10 stores the main model ID, the data IDs of the items of data classified into the group, and the number of items of data classified into the group, in the entries of the main model ID, the data IDs, and the data count of a new record of the group table 1022. As a group ID, group identification information is newly numbered.

Note that group error data, group fault information, and group fault type information that characterize each group (e.g., a representative vector, a centroid vector, or the like, of error data in the cluster) may be stored in the entry of the error data of the group table 1022. The group error data, the group fault information, and the group fault type information may be specified by a method to be described in Clustering Process (First Embodiment).

The controller 104 of the server 10 executes a group metadata specifying step of specifying group metadata that characterizes at least some groups of the plurality of groups on the basis of metadata associated with one or more items of data included in the group specified in the clustering step.

Specifically, for a predetermined group, the controller 104 of the server 10 looks up the data table 1013 to obtain metadata that is stored in association with data included in the group. For predetermined group information, the controller 104 of the server 10 searches the entry of the data ID of the data table 1013 on the basis of the plurality of data IDs stored in the data IDs of the group information to obtain a plurality of items of metadata that are stored in association with the plurality of items of data.

The controller 104 of the server 10 specifies, for the predetermined group, metadata having the highest number of items among the plurality of obtained items of metadata, as metadata that characterizes the predetermined group (group metadata). For example, items of metadata (nighttime, cloudy weather, vehicle speed of 50 km to 60 km) common to the plurality of items of data (items of data greater than or equal to a predetermined ratio) included in the group may be specified as the group metadata. Alternatively, metadata that characterizes each group (e.g., a representative vector, a centroid vector, or the like, of the cluster) may be specified as the group metadata.

Alternatively, the controller 104 of the server 10 may output, for the predetermined group, the group metadata by applying the plurality of obtained items of metadata to a given machine learning model, deep learning model, artificial intelligence model, or the like, as items of input data.

The controller 104 of the server 10 executes a group metadata storing step of storing the group metadata specified in the group metadata specifying step in association with at least some of the plurality of groups.

Specifically, for the predetermined group, the controller 104 of the server 10 stores the specified group metadata in the entry of the metadata of a record that is specified with the group ID of the group in the group table 1022.

### Main Model Quality Evaluation Process

In step S104, the controller 104 of the server 10 executes, on the data set obtained in the data obtaining step, a model evaluating step of evaluating, for each of the plurality of groups each including one or more items of data, the inference quality of the learning model for one or more items of data included in the group. The model evaluating step evaluates the inference quality of the learning model for one or more items of data included in the group specified in the clustering step. The model evaluating step calculates the inference accuracy of the learning model.

Specifically, on the basis of the main model ID, the controller 104 of the server 10 searches the main model ID of the group table 1022 to obtain group IDs, data counts, items of error data, and group qualities. Referring to the item of error data (group error data) and the group quality of each group, the controller 104 of the server 10 can evaluate the inference quality of the learning model for each group.

For example, the controller 104 of the server 10 compares the evaluation indices of the inference quality of each group with respective predetermined values to calculate an evaluation result pertaining to the inference quality such as the number of groups having inference qualities sufficiently satisfactory, the number of groups having inference qualities not sufficiently satisfactory, the degree of the inference quality of each group (determined on the basis of the evaluation indices), and the number of items of data included in each group.

In addition, on the basis of the main model ID, the controller 104 of the server 10 searches the main model ID of the evaluation table 1014 to obtain inference data and error data. On the basis of the obtained inference data and error data, the controller 104 of the server 10 calculates a coverage of the number of data sets that can be appropriately inferred (without errors) with respect to the number of the data sets, as an evaluation result pertaining to the inference quality.

Alternatively, the controller 104 of the server 10 may output the evaluation result pertaining to the inference quality by applying the obtained inference data and error data to a given machine learning model, deep learning model, artificial intelligence model, or the like, as items of input data.

The controller 104 of the server 10 stores the evaluation result pertaining to the inference quality in the entry of the model quality of a record that is specified on the basis of the main model ID in the model table 1021. Thus, the model quality is stored in association with the main model.

### Evaluation Result Presentation Process

In step S105, the controller 104 of the server 10 executes a quality presenting step of presenting the plurality of groups in association with the inference qualities evaluated in the model evaluating step.

On the basis of the main model ID, the controller 104 of the server 10 searches the group table 1022 to obtain group information. The controller 104 of the server 10 transmits the obtained group information to the user terminal 20. On the basis of the received group information, the controller 204 of the user terminal 20 generates an evaluation result presentation screen and displays the screen on the display device 2081 of the user terminal 20, thus presenting the screen to the user.

This makes it possible to interpret the quality of the entire learning model in perspective for each group range of the data set. For example, it is possible to visually and intuitively check what proportion of the data set has resulted in a good inference quality and what proportion of the data set has resulted in a bad inference quality.

FIG. 13 is the first screen example of the evaluation result presentation screen.

An evaluation result presentation screen D1 shows how 204 records of the group information are presented as a list in a tabular form including the columns of the indices D11, D12, and D13 pertaining to the group quality, and the data count D14, included in the group information. Note that, in the present disclosure, only groups with the group qualities that are less than or equal to a predetermined value (poor) (will be called hot spots) are listed, and groups with the group qualities that are greater than or equal to a predetermined value (satisfactory) are excluded. Note that both the groups with the group qualities that are less than or equal to the predetermined value (poor) (will be called hot spots) and the groups with the group qualities that are greater than or equal to the predetermined value (satisfactory) may be listed.

The user can sort the plurality of presented pieces of group information in accordance with the order of one of the indices D11, D12, and D13 pertaining to the group quality, the data count D14, and the like.

Alternatively, the group information may be visualized in not only tabular form but also any form, such as a treemap, in which a hierarchical structure is defined for the similarities among items of group metadata or defined for groups from the group qualities.

The quality presenting step presents the plurality of groups in association with degrees of influence pertaining to the degrees to which the groups influence the learning model and that are calculated on the basis of the inference qualities evaluated in the model evaluating step.

The evaluation result presentation screen D1 includes model_effect_score. This makes it possible to interpret the quality of the entire learning model in perspective for each group range of the data set in accordance with the degree of influence on the learning model.

FIG. 14 is the second screen example of the evaluation result presentation screen.

An evaluation result presentation screen D3 includes a heat map D30. The heat map is a two-dimensional space into which a multidimensional space created on the basis of the items of metadata of the data set is mapped by a given subspace method, multidimensional scaling, or the like. The heat map D30 includes points D31, D32, . . . Note that the points D31, D32, . . . are drawn in different colors in accordance with the evaluation indices of the inference qualities included in the group qualities of the corresponding groups. Specifically, the drawing may be gradational such that a more satisfactory inference quality may be drawn in darker green, and a poorer inference quality may be drawn in darker red.

The heat map D30 illustrates the extent of the space of the items of metadata, and the positions of the groups in the space are drawn as the points D31, D32, . . .

Taking a bird's eye view of the heat map D30, the user can visually and intuitively check where groups having satisfactory inference qualities and groups having poor inference qualities are positioned in the space of the items of metadata (whether the main model is weak in what metadata region).

### Selecting Group

In step S106, the controller 204 of the user terminal 20 executes a group selecting step of accepting, from the user, the selection of a predetermined group from among the plurality of groups.

The user can select a group (a row) included in the evaluation result presentation screen D1 by operating the input device 206 of the user terminal 20.

Operating the input device 206 of the user terminal 20, the user can select the points D31, D32, . . . included in the evaluation result presentation screen D3.

The controller 204 of the user terminal 20 obtains and accepts the group ID that is associated with the selected group.

Note that step S106 may be omitted. For example, the controller 104 of the server 10 may be configured to automatically select, from the group table 1022, a group that satisfies a predetermined condition, such as a condition that a group quality is less than or equal to the predetermined value (e.g., its inference quality is poor), without accepting a selecting operation from the user.

Alternatively, the configuration may be such that the user operates the input device 206 of the user terminal 20 to execute a command line or a given program, thereby executing the group selecting step of accepting the selection of a predetermined group from among the plurality of groups.

### Creating Submodel

In step S107, the controller 104 of the server 10 executes a model modifying step of creating a modified function that is obtained by modifying the learning model stored in the model storing step on the basis of one or more items of data included in the group.

The model modifying step creates the modified function obtained by modifying the learning model stored in the model storing step on the basis of one or more items of data included in the predetermined group selected in the group selecting step.

The model modifying step creates the modified function obtained by modifying the learning model on the basis of the inference quality of the group that is specified by applying the one or more items of data included in the group as input data of the learning model.

Specifically, on the basis of the group ID of the group selected in step S106, the controller 104 of the server 10 searches the group ID of the group table 1022 to obtain group information including data IDs, metadata, error data, and a group quality. The controller 104 of the server 10 transmits the group information to the user terminal 20. The controller 204 of the user terminal 20 displays and presents the received group information on the display device 2081 of the user terminal 20. The user can check a group having a poor inference quality together with its metadata, error data, and the detail of the group quality.

Operating the input device 206 of the user terminal 20, the user creates a learning model (modified model, submodel) obtained by modifying the main model, while referring to the group information such as the metadata, error data, group quality, and the like.

Specifically, for a group having a poor inference quality, the user creates a submodel that is superior to the main model in inference quality for the data set included in the group. Note that, the following method is a conceivable method for creating the submodel, while any method is applicable.
The main model that is retrained on the basis of the test data included in the group is taken as the submodel.
The main model that is modified by feature engineering, such as deleting an unimportant feature, creating a new feature, or converting an existing feature, is taken as the submodel. The feature engineering may be automatically executed or may be performed by the user.
The main model subjected to adjustment of a hyperparameter, such as learning rate, regularization parameter, or model depth, is taken as the submodel. The adjustment may be automatically executed or may be performed by the user.
The main model that is fine-tuned on the basis of predetermined data may be taken as the submodel.

Note that, in the present disclosure, the example of creating the modified model is described as an example, but the method of creating the submodel is not limited to this. For example, the configuration may be such that any function (a function that maps an input value to a predetermined output value), a constant function that outputs a predetermined constant irrespective of an input value, or a modified function including the modified model already described (a preprocessing or postprocessing function) is created. Note that the case where the modified model is used as the modified function is described as an example in an embodiment of the present disclosure, but the scope of the application of the present disclosure is not limited to this.

In step S107, the controller 104 of the server 10 executes a condition storing step of storing an application condition for applying the modified function created in the model modifying step, in association with the modified function. The condition storing step stores, as the application condition, group metadata that is stored in association with the group of the modified function created in the model modifying step, in association with the modified function.

Specifically, the controller 104 of the server 10 stores the main model ID, the created submodel, and the metadata included in the group information on the selected group (group metadata) in the entry of the main model ID, the submodel, and the application condition of a new record of the submodel table 1023.

Note that, in the present disclosure, the range of the metadata is described as the application condition, as an example, but the application condition is not limited to this. For example, the combination of any one, or two or more of the metadata, error data (group error data), group quality, and the like included in the group information may be taken as the application condition. In addition, the application condition may include a condition for information about the internal features output from the internal layer of the main model. That is, the application condition may include a condition pertaining to output data that is output from the main model that once receives input data.

Alternatively, the user may define any condition as the application condition for the submodel.

Note that, in the present disclosure, the created modified function is used to create the combined model in step S108 described later, but the use of the modified function is not limited to this. For example, the modified function may be used to check a data set or modifying a data set, or may be configured to be capable of outputting output data for the examination or the modification. For example, in the case where a data set itself created by a user has a low quality (e.g., the case where an image of “dog” is annotated as “cat,” etc.), there may be a case where the modified function outputs an inference result that is seemingly false (e.g., “dog” for the annotation of “cat”), but the inference result is actually true (“dog” output by the modified function is actually true).

In such a case, the modified function may output information for executing a notification, such as an alert, to the user. The controller 104 of the server 10 notifies the user of a detailed output in accordance with the information output by the modified function. Alternatively, the modified function may be configured to modify a data set.

### Creating Combined Model

In step S108, the controller 104 of the server 10 executes a combined model creating step of creating a combined model on the basis of the learning model and the modified function.

Specifically, the controller 104 of the server 10 creates the combined model by combining the main model and one or more submodels.

FIG. 12 is a block diagram illustrating a functional configuration of a combined model. The operation of the combined model will be described later in Combined Model Inference Process.

Note that the combined model may be configured as a model different from the main model, or the one or more submodels, or may be configured as a model into which the main model and the one or more submodels are combined.

In the present disclosure, the combined model includes a model into which the main model and the one or more submodels are combined such that a specific region of input data is input as input data into the one or more submodels. The combined model includes a model into which the main model and the one or more submodels are combined such that output data output by the one or more submodels serves as a specific region of output data of the main model.

In the case where input data is included in the application condition stored in the condition storing step, the combined model created in the combined model creating step outputs output data from the modified model associated with the application condition, and in the case where input data is not included in the application condition stored in the condition storing step, the combined model outputs output data from the learning model.

In the case where metadata associated with input data is included in group metadata, the combined model created in the combined model creating step outputs output data from the modified model associated with the group metadata, and in the case where metadata associated with input data is not included in group metadata, the combined model outputs output data from the learning model.

The inference process by the combined model will be described in detail in Combined Model Inference Process.

### Combined Model Inference Process

The combined model inference process is a process of interring output data for input data on the basis of the combined model into which two types of learning models: the main model and the submodel are combined.

### Outline of Combined Model Inference Process

The combined model inference process is a series of processes of accepting input data, selecting a learning model to which the input data is to be applied, from among the main model and one or more submodels on the basis of the accepted input data, and applying the input data to the learning model, thus outputting output data as an inference result.

### Details of Combined Model Inference Process

Hereinafter, the details of the combined model inference process will be described.

In step S301, the controller 104 of the server 10 accepts the input data. The data to be accepted may be the test data included in the data set accepted in step S101 of the quality evaluation process.

Note that the input data may be accepted from a user, or actual environment data obtained by performing image capturing with an on-board camera in a production environment of a given information processing service or the like may be accepted as the input data. The method for accepting the input data is not limited.

In step S302, the controller 104 of the server 10 determines whether metadata included in the input data is included (matches) in an application condition in the submodel table 1023.

In the case where submodel information relating to the matching application condition can be specified (in the case where at least one record can be extracted from the submodel table 1023), the controller 104 of the server 10 specifies a submodel included in the record extracted from the submodel table 1023. Note that the configuration may be such that, in the case where a plurality of records are extracted, only one submodel is selected according to a given algorithm. For example, submodels may be assigned priorities for the extraction, or the submodel may be extracted at random.

In the case where no submodel information relating to the matching application condition can be specified (at least one record cannot be extracted from the submodel table 1023), the controller 104 of the server 10 specifies the main model.

This makes it possible to create a combined model that switches a model to be applied to any one of the modified model and the learning model, according to the range of the metadata on the input data. The combined model is capable of outputting output data having an inference quality superior to the main model for the input data.

Note that, in the present disclosure, the range of the metadata is described as the application condition, as an example, but the application condition is not limited to this. It is sufficient that the controller 104 of the server 10 specifies the submodel in the case where the input data accepted in step S301 is included in an application condition or specifies the main model in the case where the input data is not included in the application condition.

The selection of the model to be applied need not necessarily be executed before the input data is input into any one of the main model and the submodel. The configuration may be such that, for example, in the case where the application condition for the submodel includes a condition pertaining to internal features output from the internal layer of the main model receiving the input data, the application of the submodel is selected in accordance with information on the output data output from the input data. That is, the output data output from the main model may be included in the application condition. In this case, the input data to be input into the submodel need not necessarily be the input data accepted in step S301. The output data of the main model may be input into the submodel.

As seen from the above, the combined model in the present disclosure is not limited to the case where the input data accepted in step S301 is selectively input into any one of the main model and the submodel. The combined model may be configured such that the submodel is selected in accordance with the content of the output data output from the main model. Alternatively, in the case where the quality of the output data of the main model in response to the input data is insufficient (in the case where reliability, accuracy, or the like is low compared with a predetermined value), output data from the submodel may be used as output data of the combined model.

In step S303, the controller 104 of the server 10 inputs, as input data, the input data accepted in step S301 into the submodel or the main model specified in step S302. The controller 104 of the server 10 obtains output data output from the submodel or the main model.

In the case where the submodel is specified in step S302, the controller 104 of the server 10 obtains, as the output data, an inference result from the submodel for the input data. In the case where the main model is specified in step S302, the controller 104 of the server 10 obtains, as the output data, an inference result from the main model for the input data.

This makes it possible to create a combined model by switching a model to be applied to any one of the modified model and the learning model, according to the range of the input data (the range of a group). The combined model is capable of outputting output data having a superior inference quality for the input data input into the combined model.

In step S302, in the case where the application condition for the submodel includes a condition pertaining to internal features output from the internal layer of the main model receiving the input data, it is preferable to take the output data from the submodel as the output data of the combined data. It is thus possible to output output data having a superior inference quality for the input data input into the combined model.

FIG. 12 is a block diagram illustrating a functional configuration of a combined model. The combined model inference process will be described on the basis of a functional block diagram of the combined model. A combined model M1 outputs output data M18 in response to the input of input data M11. On the input data M11 input into the combined model M1, validation M12 pertaining to the input data is executed. In accordance with the result of the validation on the input data M11, the input data M11 is input into any one of a main model M13 or a submodel M14.

The main model M13 outputs output data in response to the input of the input data M11, and validation M15 pertaining to the output data is executed. Likewise, the submodel M14 outputs output data in response to the input of the input data M11, and validation M16 pertaining to the output data is executed. Note that, in the case where the application condition includes a condition pertaining to internal features output from the internal layer of the main model, in accordance with the result of the validation M15, the input data M11 or the output data of the main model is input into the submodel M14 when the application condition applies. In this case, the output data of the submodel M14 is output as the output data M18 of the combined model M1, and the output data of the main model M13 is not output as the output data M18 of the combined model M1.

The output data from the main model M13 or the submodel M14 is output as the output data M18 of the combined model M1. Note that the output data from the submodel M14 is subjected to manual check M17 in accordance with the result of the validation M16 pertaining to the output data, and the output data that has been subjected to the manual check is also reflected in the output data M18. Note that the check M17 need not necessarily be executed on the output data from the submodel M14. For example, in the case where a data set itself created by a user has a low quality (e.g., the case where an image of “dog” is annotated as “cat,” etc.), there may be a case where the modified function outputs an inference result that is seemingly false (e.g., “dog” for the annotation of “cat”), but the inference result is actually true (“dog” output by the modified function is actually true).

In such a case, the validation M16 pertaining to the output data of the submodel is subjected to the process of executing a notification such as an alert, to the user, and the manual check M17 is executed.

Note that the main model M13 and the submodel M14 mentioned here may each have a configuration in which a plurality of models, modified functions, and the like are combined, or a configuration in which an additional submodel follows the validation M16.

### Basic Hardware Configuration of Computer

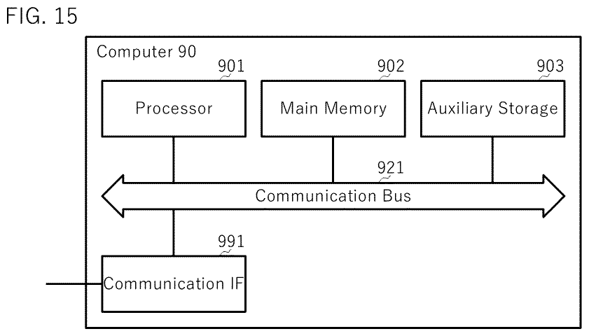

FIG. 15 is a block diagram illustrating a basic hardware configuration of a computer 90. The computer 90 includes at least a processor 901, a main storage device 902, an auxiliary storage device 903, and a communication interface (IF) 991. These are electrically connected to one another by a communication bus 921.

The processor 901 is a piece of hardware for executing a set of instructions written in a program. The processor 901 is constituted by an arithmetic unit, registers, peripheral circuits, and the like.

The main storage device 902 is for temporarily storing a program, and data and the like that are to be processed by the program. For example, the main storage device 902 is a volatile memory such as a dynamic random access memory (DRAM) or the like.

The auxiliary storage device 903 is a storage device for saving data and a program. For example, the auxiliary storage device 903 is a flash memory, a hard disc drive (HDD), a magneto-optical disk, a CD-ROM, a DVD-ROM, a semiconductor memory, or the like.

The communication IF 991 is an interface for inputting and outputting signals for communication with another computer via a network, according to a wired or wireless communication standard.

The network is constituted by one of various mobile telecommunications systems that is built with the Internet, a LAN, a wireless base station, and the like. For example, the network includes a 3G, 4G, or 5G mobile telecommunications system, Long Term Evolution (LTE), a wireless network, which enables connection to the Internet from a predetermined access point (e.g., Wi-Fi (R)), and the like. In the case of wireless connection, its communication protocol includes, for example, Z-Wave (R), ZigBee (R), Bluetooth (R), and the like. In the case of wired connection, the network also includes a direct connection with a universal serial bus (USB) cable or the like.

Note that the computer 90 can be virtually implemented with a plurality of computers 90 that are provided with the entire or part of the hardware configurations in a distributed manner and connected to one another via a network. As seen from the above, the computer 90 is a concept that encompasses not only a computer 90 housed in a single housing or case but also a virtualized computer system.

### Basic Functional Configuration of Computer 90

A functional configuration of the computer implemented with the basic hardware configuration of the computer 90 (FIG. 15) will be described. The computer includes at least functional units including a controller, a storage, and a communicator.

Note that the functional units included in the computer 90 can be implemented by providing the entire or part of each of the functional units to a plurality of computers 90 connected to one another via a network in a distributed manner. The computer 90 is a concept that encompasses not only a single computer 90 but also a virtualized computer system.

The controller is implemented by the processor 901 reading various programs stored in the auxiliary storage device 903, loading the programs on the main storage device 902, and executing processes according to the programs. The controller can implement a functional unit that performs various types of information processing in accordance with the types of the programs. Thus, the computer is provided in the form of an information processing apparatus performing the information processing.

The storage is implemented by the main storage device 902 and the auxiliary storage device 903. The storage stores data, various programs, and various databases. In addition, the processor 901 can reserve a storage area corresponding to the storage in the main storage device 902 or the auxiliary storage device 903, according to a program. In addition, the controller can cause the processor 901 to execute the process of adding, updating, or deleting data stored in the storage, according to various programs.

The database refers to a relational database. The database is for maintaining a tabular-form table that is structurally defined with rows and columns and a data collection called a master, in association with each other. In a database, a table is called a table or master, a column of a table is called column, and a row of a table is called a record. In a relational database, the relation between a table and a master can be set, and the table and the master can be associated with each other.

In general, a column that serves as a primary key for uniquely specifying a record is set for each table or master. However, setting a primary key to a column is not indispensable. The controller can cause the processor 901 to execute the addition, deletion, and update of a record in a specific table or master stored in the storage, according to various programs.

Causing the storage to store the data, the various programs and the various databases can be considered as producing the information processing apparatus or the information processing system according to the present disclosure.

Note that the database and the master in the present disclosure can include any data structure (list, dictionary, associative array, object, etc.) that structurally define information. It is assumed that the data structure includes data that includes data and a function, a class, a method, or the like written in any programming language in combination and can thus be regarded as a data structure.

The communicator is implemented with the communication IF 991. The communicator implements the function of communicating with another computer 90 via a network. The communicator can receive information transmitted from the other computer 90 and input the information into the controller. The controller can cause the processor 901 to execute information processing on the received information, according to various programs. In addition, the communicator can transmit information output from the controller to the other computer 90.

### Supplements

The matters described in the above-described embodiments will be supplemented below.

### Supplement 1

A program to be executed by a computer including a processor and a storage, wherein the processor executes: a model storing step (S101) of storing a learning model; a data obtaining step (S102) of obtaining a data set including a plurality of items of data each of which is associated with an item of metadata; and a model evaluating step (S104) of evaluating, on the data set obtained in the data obtaining step, inference qualities of learning model for one or more items of data included in the group for each of a plurality of groups each including one or more items of data.

It is thus possible to evaluate the inference qualities of the learning model for each group. For example, a weak region for the learning model can be specified as a group.

### Supplement 2

The program according to Supplement 1, wherein the model evaluating step (S104) is a step of calculating an inference accuracy of the learning model.

It is thus possible to evaluate the inference accuracy of the learning model for each group.

### Supplement 3

The program according to Supplement 1 or 2, wherein the processor executes: a data inferring step (S103) of obtaining an inference result for each of the plurality of items of data included in the data set obtained in the data obtaining step by applying each of the plurality of items of data as an item of input data of the learning model stored in the model storing step; and a clustering step (S103) of executing clustering based on the inference result obtained in the data inferring step and specifying a cluster formed by the clustering as a group, and the model evaluating step (S104) is a step of evaluating inference qualities of the learning model for one or more items of data included in the group specified in the clustering step.

It is thus possible to evaluate the inference qualities of the learning model for the range of each cluster that is specified in accordance with the inference result.

### Supplement 4

The program according to Supplement 3, wherein the data inferring step (S103) is a step of obtaining items of fault information about faults in inference results for at least some of the plurality of items of data, and the clustering step (S103) is a step of executing clustering on the data set obtained in the data obtaining step, on a basis of similarities among the items of fault information obtained in the data inferring step, and specifying a cluster formed by the clustering as a group.

It is thus possible to evaluate the inference qualities of the learning model for the range of each cluster that is specified in accordance with similarities among the faults in the inference results.

### Supplement 5

The program according to Supplement 4, wherein the data inferring step (S103) is a step of obtaining items of fault type information about types of faults in inference results for at least some of the plurality of items of data, and the clustering step (S103) is a step of executing clustering on the data set obtained in the data obtaining step, on a basis of similarities among the items of fault type information obtained in the data inferring step, and specifying a cluster formed by the clustering as a group.

It is thus possible to evaluate the inference qualities of the learning model for the range of each cluster that is specified in accordance with similarities among the types of the faults in the inference results.

### Supplement 6

The program according to any one of Supplements 3 to 5, wherein the processor executes: a group metadata specifying step (S103) of specifying group metadata that characterizes at least some groups of the plurality of groups, on a basis of metadata associated with the one or more items of data included in the group specified in the clustering step; and a group metadata storing step (S103) of storing the group metadata specified in the group metadata specifying step in association with the at least some groups of the plurality of groups.

It is thus possible to interpret, for the range of each cluster that is specified in accordance with the inference result, the detail of the cluster on the basis of the group metadata. For example, for a cluster of bad inference qualities, a factor in the poor inference qualities can be interpreted on the basis of the metadata.

### Supplement 7

The program according to Supplement 1 or 2, wherein the processor executes a clustering step (S103) of executing clustering based on similarities among items of metadata on the data set obtained in the data obtaining step and specifying a cluster formed by the clustering as a group, and the model evaluating step (S104) is a step of evaluating inference qualities of the learning model for one or more items of data included in the group specified in the clustering step.

It is thus possible to evaluate the inference qualities of the learning model for the range of each cluster that is specified in accordance with the similarities among the items of metadata.

### Supplement 8

The program according to Supplement 7, wherein the processor executes: a group quality evaluating step (S103) of obtaining an inference result for each of the one or more items of data included in the group specified in the clustering step by applying each of the one or more items of data as an item of input data of the learning model stored in the model storing step; a group quality specifying step (S103) of specifying a group inference quality that characterizes at least some groups of the plurality of groups, on a basis of the inference results obtained in the group quality evaluating step; and a group quality storing step (S103) of storing the group inference quality specified in the group quality specifying step in association with the at least some groups of the plurality of groups.

It is thus possible to evaluate the inference qualities of the learning model for the range of each cluster that is specified in accordance with the similarities among the items of metadata.

### Supplement 9

The program according to Supplement 8, wherein, the group quality evaluating step (S103) is a step of obtaining an item of fault information about a fault in an inference result for each of the one or more items of data, the group quality specifying step (S103) is a step of specifying group fault information that characterizes the at least some groups of the plurality of groups, and the group quality storing step (S103) is a step of storing the group fault information specified in the group quality specifying step in association with the at least some groups of the plurality of groups.

It is thus possible to evaluate the inference quality pertaining to a fault in an inference result of the learning model for the range of each cluster that is specified in accordance with the similarities among the items of metadata.

### Supplement 10

The program according to Supplement 9, wherein, the group quality evaluating step (S103) is a step of obtaining an item of group fault type information about a type of a fault in an inference result for each of the one or more items of data, the group quality specifying step (S103) is a step of specifying group fault type information that characterizes the at least some groups of the plurality of groups, and the group quality storing step (S103) is a step of storing the group fault type information specified in the group quality specifying step in association with the at least some groups of the plurality of groups.

It is thus possible to evaluate the inference quality pertaining to the type of a fault in an inference result of the learning model for the range of each cluster that is specified in accordance with the similarities among the items of metadata.

### Supplement 11

The program according to any one of Supplements 1 to 10, wherein the processor executes a quality presenting step (S105) of presenting the plurality of groups in association with the inference qualities evaluated in the model evaluating step.

This makes it possible to interpret the quality of the entire learning model in perspective for each group range of the data set. For example, it is possible to visually and intuitively check what proportion of the data set has resulted in a good inference quality and what proportion of the data set has resulted in a bad inference quality.

### Supplement 12

The program according to Supplement 11, wherein the quality presenting step (S105) is a step of presenting the plurality of groups in association with degrees of influence pertaining to degrees to which the groups influence the learning model and that are calculated on the basis of the inference qualities evaluated in the model evaluating step.

This makes it possible to interpret the quality of the entire learning model in perspective for each group range of the data set in accordance with the degree of influence on the learning model.

### Supplement 13

The program according to any one of Supplements 1 to 12, wherein the processor executes a model modifying step (S107) of creating a modified function that is obtained by modifying the learning model stored in the model storing step, on a basis of one or more items of data included in the group.

It is thus possible to create the modified function that is the learning model modified for each group.

### Supplement 14

The program according to Supplement 13, wherein the model modifying step (S107) is a step of creating the modified function obtained by modifying the learning model on a basis of an inference quality of a group that is specified by applying the one or more items of data included in the group as input data of the learning model.

It is thus possible to create the modified function that is the learning model modified for, for example, a specific group for which the inference quality of the learning model is low.

### Supplement 15

The program according to Supplement 13, wherein the processor executes a group selecting step (S106) of accepting, from a user, selection of a predetermined group from among the plurality of groups, and the model modifying step (S107) is a step of creating the modified function obtained by modifying the learning model stored in the model storing step, on a basis of one or more items of data included in the predetermined group selected in the group selecting step.

It is thus possible to create, in accordance with the selection of the group by the user, the modified function that is the learning model modified for the selected group.

### Supplement 16

The program according to any one of Supplements 13 to 15, wherein the processor executes: a condition storing step (S107) of storing an application condition for applying the modified function created in the model modifying step, in association with the modified function; and a combined model creating step (S108) of creating a combined model on a basis of the learning model and the modified function, wherein in a case where input data is included in the application condition stored in the condition storing step, the combined model created in the combined model creating step outputs output data from the modified function associated with the application condition, and in a case where input data is not included in the application condition stored in the condition storing step, the combined model outputs output data from the learning model.

This makes it possible to create a combined model by switching a model to be applied to any one of the modified function and the learning model, according to the range of the input data (the range of a group). The combined model is capable of outputting output data having a superior inference quality for the input data.

### Supplement 17

The program according to Supplement 16, wherein the processor executes: a group metadata specifying step (S103) of specifying group metadata that characterizes at least some groups of the plurality of groups, on a basis of metadata associated with the one or more items of data included in the group; and a group metadata storing step (S103) of storing the group metadata specified in the group metadata specifying step in association with the at least some groups of the plurality of groups, the condition storing step (S107) is a step of storing, as the application condition, the group metadata stored in association with the group of the modified function created in the model modifying step, in association with the modified function, and the combined model created in the combined model creating step outputs, in a case where metadata associated with input data is included in group metadata, output data from the modified function associated with the group metadata, and output, in a case where the metadata associated with the input data is not included in the group metadata, output data from the learning model.

This makes it possible to create a combined model by switching a model to be applied to any one of the modified function and the learning model, according to the range of the metadata on the input data. The combined model is capable of outputting output data having a superior inference quality for the input data.

### Supplement 18

A method to be executed by a computer including a processor and a memory, wherein the processor executes all steps executed in the disclosure s according to any one of Supplement 1 to Supplement 17.

It is thus possible to evaluate the inference qualities of the learning model for each group. For example, a weak region for the learning model can be specified as a group.

### Supplement 19

An information processing apparatus including a controller and a storage, wherein the controller executes all steps executed in the disclosures according to any one of Supplement 1 to Supplement 17.

It is thus possible to evaluate the inference qualities of the learning model for each group. For example, a weak region for the learning model can be specified as a group.

### Supplement 20

A system comprising means for executing all steps executed in the disclosures according to any one of Supplement 1 to Supplement 17.

It is thus possible to evaluate the inference qualities of the learning model for each group. For example, a weak region for the learning model can be specified as a group.

What is claimed is:

1. An information processing apparatus comprising:
processing circuitry configured to:
store a learning model;
obtain a data set including a plurality of items of data each of which is associated with an item of metadata; and
evaluate, on the obtained data set, for each of a plurality of groups each including one or more items of data, an inference quality of the learning model for the one or more items of data included in the group.

2. The information processing apparatus according to claim 1, wherein
the processing circuitry is configured to evaluate the inference quality by calculating an inference accuracy of the learning model.

3. The information processing apparatus according to claim 1, wherein
the processing circuitry is further configured to:
obtain an inference result for each of the plurality of items of data included in the obtained data set by applying each of the plurality of items of data as an item of input data of the stored learning model; and
execute clustering based on the obtained inference result and specify a cluster formed by the clustering as a group, wherein
the processing circuitry evaluates an inference quality of the learning model for one or more items of data included in the specified group.

4. The information processing apparatus according to claim 3, wherein
the processing circuitry is further configured to:
obtain items of fault information about faults in inference results for at least some of the plurality of items of data; and
execute, on the obtained data set, clustering based on similarities among the obtained items of fault information, and specify a cluster formed by the clustering as a group.

5. The information processing apparatus according to claim 4, wherein
the processing circuitry is further configured to:
obtain items of fault type information about types of faults in inference results for at least some of the plurality of items of data; and
execute, on the obtained data set, clustering based on similarities among the obtained items of fault type information, and specify a cluster formed by the clustering as a group.

6. The information processing apparatus according to claim 3, wherein
the processing circuitry is further configured to:
specify group metadata that characterizes at least some groups of the plurality of groups on a basis of metadata associated with one or more items of data included in the specified group; and
store the specified group metadata in association with at least some of the plurality of groups.

7. The information processing apparatus according to claim 1, wherein
the processing circuitry is further configured to:
execute, on the obtained data set, clustering based on similarities among the items of metadata, and specify a cluster formed by the clustering as a group; and
evaluate an inference quality of the learning model for one or more items of data included in the specified group.

8. The information processing apparatus according to claim 7, wherein
the processing circuitry is further configured to:
apply each of the one or more items of data included in the specified group, as an item of input data of the stored learning model, to obtain an inference result for each of the one or more items of data;
specify, on a basis of the obtained inference result, a group inference quality that characterizes at least some groups of the plurality of groups; and
store the specified group inference quality in association with at least some of the plurality of groups.

9. The information processing apparatus according to claim 8, wherein
the processing circuitry is configured to:
obtain fault information about a fault in an inference result for each of the one or more items of data;
specify group fault information that characterizes at least some groups of the plurality of groups; and
store the specified group fault information in association with at least some of the plurality of groups.

10. The information processing apparatus according to claim 9, wherein
the processing circuitry is configured to:
obtain group fault type information about a type of a fault in an inference result for each of the one or more items of data;
specify group fault type information that characterizes at least some groups of the plurality of groups; and
store the specified group fault type information in association with at least some of the plurality of groups.

11. The information processing apparatus according to claim 1, wherein the processing circuitry is further configured to present the plurality of groups in association with the evaluated inference quality.

12. The information processing apparatus according to claim 11, wherein the processing circuitry presents the plurality of groups in association with degrees of influence pertaining to degrees to which the groups influence the learning model and that are calculated on a basis of the evaluated inference quality.

13. The information processing apparatus according to claim 1, wherein the processing circuitry is further configured to create a modified function that is obtained by modifying the stored learning model on a basis of one or more items of data included in the group.

14. The information processing apparatus according to claim 13, wherein the processing circuitry creates the modified function obtained by modifying the learning model on a basis of the inference quality of the group that is specified by applying one or more items of data included in the group as input data of the learning model.

15. The information processing apparatus according to claim 13, wherein
the processing circuitry is further configured to:
accept, from a user, selection of a predetermined group from among the plurality of groups; and
create the modified function obtained by modifying the stored learning model on a basis of one or more items of data included in the accepted predetermined group.

16. The information processing apparatus according to claim 13, wherein
the processing circuitry is further configured to:
store an application condition for applying the created modified function, in association with the modified function; and
create a combined model on a basis of the learning model and the modified function, and
the created combined model:
outputs, in a case where input data is included in the stored application condition, output data from the modified function associated with the application condition; and
outputs, in a case where input data is not included in the stored application condition, output data from the learning model.

17. The information processing apparatus according to claim 16, wherein
the processing circuitry is further configured to:
specify group metadata that characterizes at least some groups of the plurality of groups on a basis of metadata associated with one or more items of data included in the group; and
store the specified group metadata in association with at least some of the plurality of groups,
the processing circuitry stores, as the application condition, the group metadata stored in association with the group of the created modified function, in association with the modified function, and
the created combined model:
outputs, in a case where metadata associated with input data is included in the group metadata, output data from the modified function associated with the group metadata; and
outputs, in a case where the metadata associated with the input data is not included in the group metadata, output data from the learning model.

18. A method executed by a computer including a processor and a memory, the method comprising:
storing a learning model;
obtaining a data set including a plurality of items of data each of which is associated with an item of metadata; and
evaluating, on the obtained data set, for each of a plurality of groups each including one or more items of data, an inference quality of the learning model for the one or more items of data included in the group.

19. A non-transitory computer-readable medium storing a program that, when executed by a computer including a processor and a memory, causes the computer to:
store a learning model;
obtain a data set including a plurality of items of data each of which is associated with an item of metadata; and
evaluate, on the obtained data set, for each of a plurality of groups each including one or more items of data, an inference quality of the learning model for the one or more items of data included in the group.
